(19) United States
(12) Patent Application Publication
(10) Pub. No.: US 2006/0180611 A1
(43) Pub. Date: Aug. 17, 2006

(54) Systems and methods for dispensing controlled portions

(76) Inventors: Gerard F. Goepfert, Scottsdale, AZ (US); Bradley M. Seames, Gilbert, AZ (US); Raymond S. Zuckerman, Scottsdale, AZ (US)

Correspondence Address: GALLAGHER & KENNEDY, P. A., 2575 E. CAMELBACK RD. #1100, PHOENIX, AZ, 85016, US

(21) Appl. No.: 11/336,757

(22) Filed: Jan. 19, 2006

Related U.S. Application Data
(60) Provisional application No. 60/645,539, filed on Jan. 19, 2005.

(51) Int. Cl. B67D 5/06; G01F 11/30

(52) U.S. Cl. 222/181.1; 222/325

(57) ABSTRACT

A controlled dose dispensing valve has two miniature poppet valves that are activated by the movement of a piston in a valve chamber to control the inward and outward flow of a liquid product into and from the valve. By adjusting the travel of the piston, the amount of liquid forced from the chamber is adjusted. The portion size is determined by adjusting the piston travel to the portion size desired. This is accomplished by adjusting the rotational position of a plunger so that one of several shoulders on the stem of a piston activating plunger is either blocked by or moved free of an interfering abutment along the plunger's path of movement.

### CROSS REFERENCE TO RELATED APPLICATIONS

This application claims priority from the provisional patent application Ser. No. 60/645,539 filed Jan. 19, 2005 in the name of Gerard F. Goepfert, Raymond S. Zuckerman and Bradley M. Seames entitled “Systems and Methods for Dispensing Controlled Portions” incorporated herein by reference.

### FIELD OF THE INVENTION

This invention relates to dispensers of liquid or semi-liquid food products, and more particularly to such a dispenser providing measured dosing of the disposed product.

### BACKGROUND OF THE INVENTION

Various types of product dispensers are used in convenience stores, fast food restaurants, coffee shops, convenience stores and the like for dispensing liquid or semi-liquid (which is to say Favorable viscous) food products (together “product”), such as, without limitation, milk for coffee cream, half and half, creamer flavorings and various condiments. Typically, a product to be dispensed is stored in a disposable bag, which is attached to a dispensing valve that has an outlet extending out of the product dispenser. When connected, a user may dispense product by pressing an actuator of the dispensing valve that permits product to flow through the valve and out of the outlet.

In most cases, product dispensers are gravity fed. In other words, the dispensing valve simply opens a flow path between the product bag and the outlet port, which permits gravity to move product along the flow path. As a result, as long as the actuator is activated and there is product remaining in the dispenser, product will continue to flow out of the dispenser. This may lead to undesirable consequences, such as making it difficult for a user to control how much product should be dispensed, because the only way a user will get a desired amount of product is by correctly timing how long he or she activates the actuator. The business proprietor may want a consistent, controlled dosage as well, to avoid waste and control cost.

Thus, it is desired that a product dispenser dispense a predetermined measured amount of product each time the dispenser is activated.

It is also desired that a user or business proprietor be able to select one out of a plurality of various predetermined measured amounts of product to be dispensed when the dispenser is activated.

### SUMMARY OF THE INVENTION

The present invention relates to disposable portion control dispensing valves to dispense liquid products (e.g., creamers, syrups, milk, etc.). These are used with a refrigerated or non-refrigerated dispensers for dispensing from above-counter or below-counter stores of product. An example of a suitable dispenser from an above-counter product store can be found in U.S. Pat. No. 6,186,361 of Teetsel entitled “Liquid Dispenser” and issued Feb. 13, 2001, incorporated herein by reference. An example of a suitable dispenser from a below-counter product store can be found in U.S. patent application Ser. No. 10/613,973 of Goepfert entitled “Under Counter Dispenser,” and filed Jun. 3, 2003, incorporated herein by reference. The valves are designed to adjust and dispense varying amounts of liquids, such as ¼ oz., ⅜ oz. & ½ oz. doses.

In general, the preferred embodiments of the portion control dispensing valve comprise two miniature poppet valves that are activated by the movement of a piston in a valve chamber to control the inward and outward flow of a liquid product into and from the valve. By adjusting the travel of the piston, the amount of liquid forced from the chamber is adjusted. The portion size is determined by adjusting the piston travel to the portion size desired. This is accomplished by adjusting the rotational position of a plunger so that one of several shoulders on the stem of a piston activating plunger is either blocked by or moved free of an interfering abutment along the plunger's path of movement.

The portion control valve has attached to its inflow aperture a connector suitable to be inserted irremovably into sterile (aseptic) and non-sterile dairy or non-dairy liquid-containing poly-bag fitments. When inserted into the poly-bag fitment, the specially designed connector penetrates the fitment's protective foil closure and locks into a non-removable, leak proof position. The locking prevents the portion control valve from being removed from the dairy bag and reused.

The portion control valve can be manually operated by pressing the plunger or electronically operated through the use of motorized activation. The manually operated plunger is spring loaded and interlocks with the portion control valve piston. The plunger is used to activate the piston inside the portion control valve. When the plunger head is pushed the portion control valve piston moves forward in its chamber opening the outflow poppet and dispensing the liquid product. As the plunger is released the spring returns the plunger to its most outward position. As the plunger returns it pulls the portion control valve piston. Backwards movement of the piston creates a vacuum or partial vacuum within the cylinder. That opens the inflow poppet and liquid product is drawn into the portion control valve's chamber. By pushing the plunger the entire process is repeated until the liquid product is exhausted. The electronically operated, motorized portion control valve will perform dispensing exactly as the manually operated valve. The electronic, motorized portion control valve plunger and piston movement is activated and controlled electronically through the use of a button switch and servo motor, for example. In either design, the plunger and the mechanism to activate the plunger (manual or electronic) are retained as permanent re-usable, non-food-contacting parts of the dispensing hardware device. Every food contacting part is designed to be disposed of with the exhausted bag to which it is attached.

This disposable portion control valve is unique in that the dosage sizes and valve sizes are variable as desired. Its dose can be altered for various liquid products such as milk, cream, half-and-half, flavorings and beverages. Designed to be disposable, it provides for food safety where liquid product is susceptible to spoilage.

### BRIEF DESCRIPTION OF THE DRAWINGS

The drawings and the associated descriptions are provided to illustrate embodiments of the invention and not to limit the scope of the invention. Throughout the drawings, reference numbers are reused to indicate correspondence between referenced elements.

FIG. 1 is a diagrammatic front view of a dispenser in accordance with an embodiment of the present invention;

FIG. 2 is a side perspective view of a valve assembly in accordance with an embodiment of the present invention;

FIG. 3 is a fragmentary perspective view of an interior portion of a product bag fitment and bag;

FIG. 4 is a side perspective view of the valve assembly of FIG. 2 showing a valve sliding into a housing;

FIG. 5 is an exploded view of housing and plunger assembly portions of the valve assembly of FIG. 2;

FIG. 6 is a front perspective view of the housing portion of the valve with the plunger portion removed;

FIG. 7 is an exploded side view of the plunger and a coupler;

FIG. 8 is a fragmentary bottom view of the plunger partially pushed into the housing portion of the valve assembly;

FIG. 9 is a side view of the valve engaged with a slide in accordance with an embodiment of the present invention;

FIG. 10 is a cross-sectional side view of the valve and slide of FIG. 9;

FIG. 11 is a perspective view of the valve and slide of FIG. 9; and

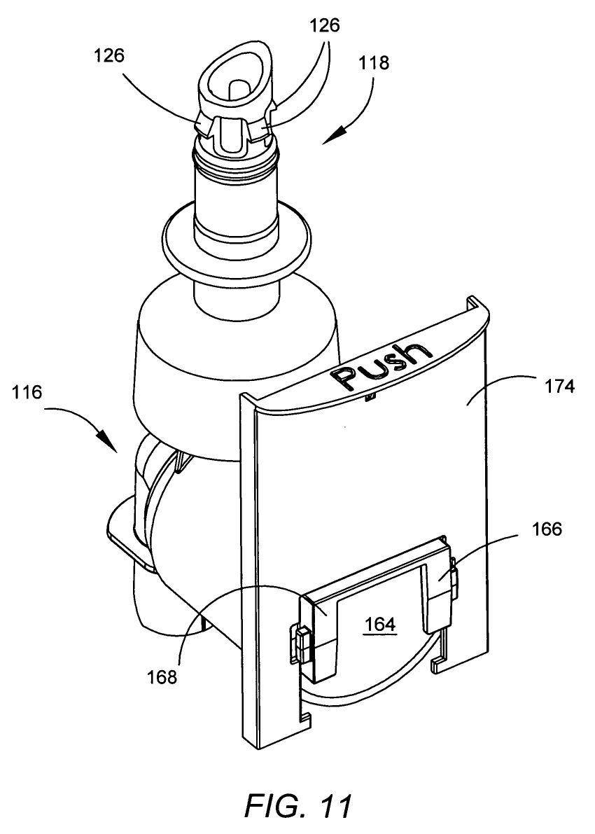

FIG. 12 is a fragmentary perspective view of the housing of FIG. 6 with the plunger of FIG. 7 inserted through a collar of the housing.

### DETAILED DESCRIPTION

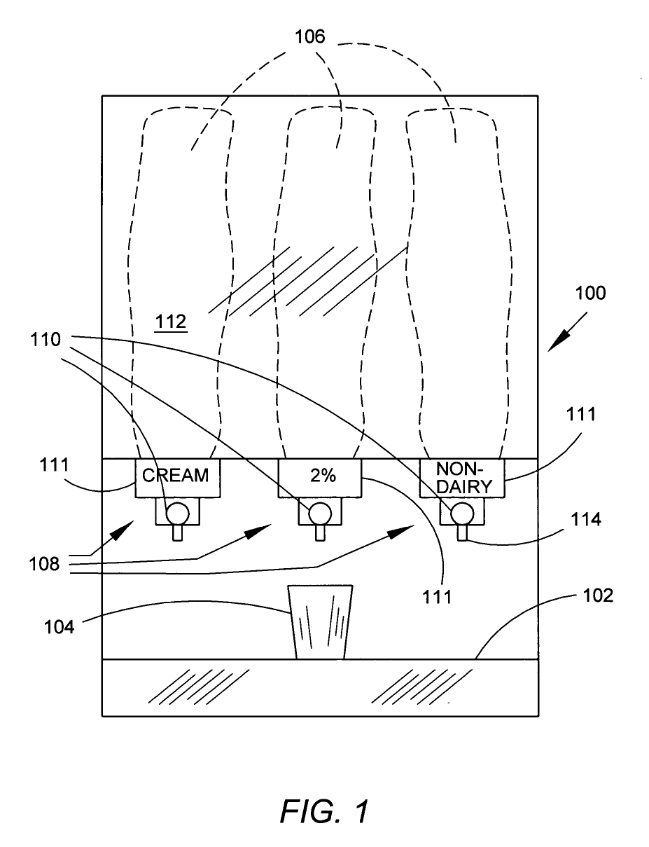

As seen in FIG. 1 a typical consumable liquid dispenser 100 has a surface 102 to support a cup 104 to dispense one of a number of products into the cup. The products are dispensed from internal flexible product-containing bags 106 through a series of valve assemblies 108 operated by the depressible heads 110 of a series of valve operating plungers. Dispensers like the dispenser 100 as shown in FIG. 1 are common place and are used widely for dispensing cream, milk or other flavorings or products into coffee or tea, for example.

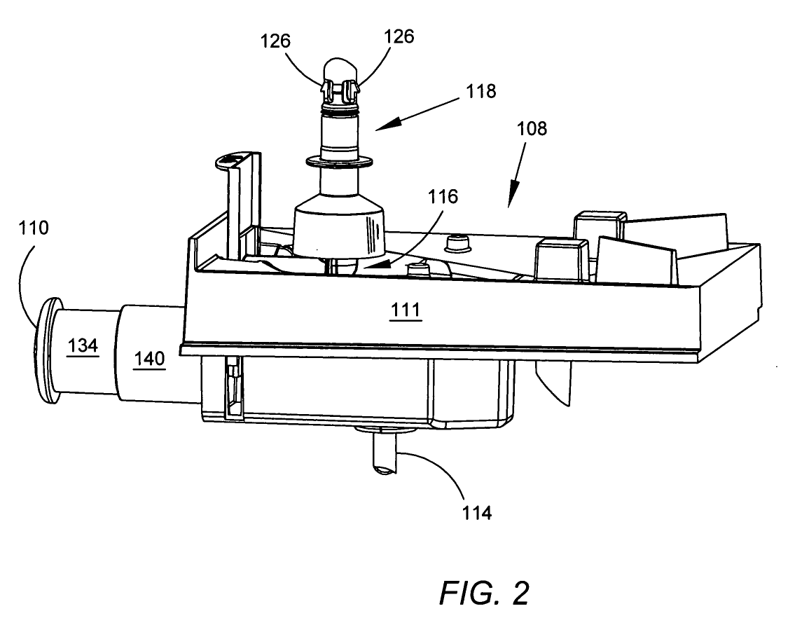

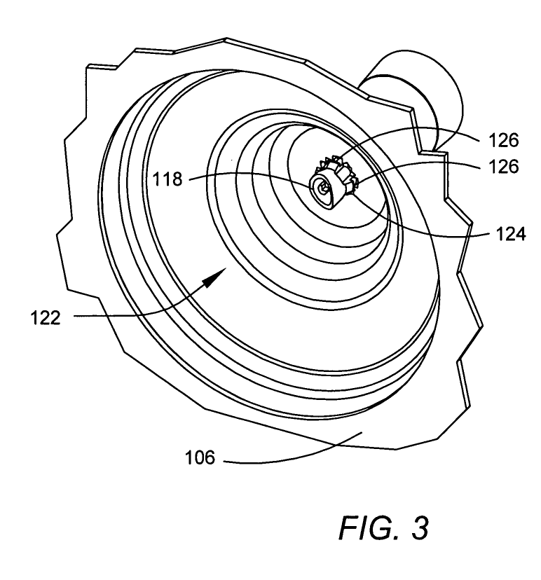

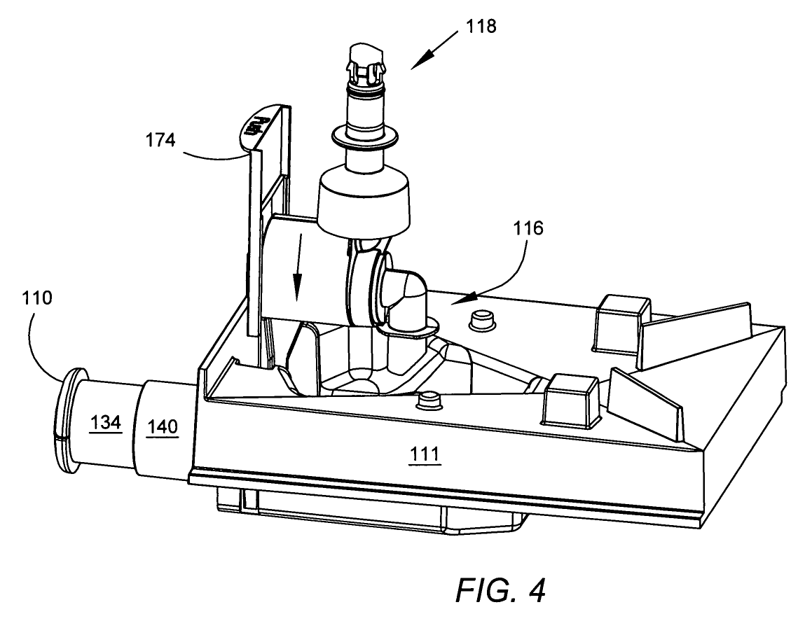

In accordance with a preferred and exemplary embodiment of the present invention, portion control is achieved in valve assemblies like those illustrated at 108 in FIG. 1. A valve assembly 108 in accordance with the invention is shown in FIG. 2. A plunger head 110 is shown at an outwardly extended position at the left in FIG. 2. A housing 111 is adapted to be slid into place and secured by conventional means (not shown) on a dispenser like the dispenser 100 illustrated in FIG. 1. A front surface 112 of the upper, product bag containing portion of the dispenser 100 may be equipped to swing open allowing replacement of the bags 106 upon exhaustion and removal and replacement of the valve assemblies 108. As seen in both FIGS. 1 and 2 the valve assemblies 108 have spouts 114 of the nature of plastic tubes opening downward from the valve assemblies. These communicate with the interior of a valve 116 an upper portion of which can be seen in FIG. 2 and as described more fully below. The valve 116 has an upwardly projecting intake connector 118 designed to interact with a fitment 122 on a conventional flexible bag 106 as partly illustrated in FIG. 3. The fitment 122 is conventional and has a circular opening sealed by a portion of thin foil 124 that is penetrated by the intake projection 118. The bag 106 and its fitment 102 are commercially available from Scholle Corporation of Chicago, Ill. Resilient plastic barbs 126 on the sides of the connector 118 are forced inward as the connector is inserted in an opening through the fitment 122. These spring outward and lock the connector 118 irremovably to the fitment upon insertion of the connector 118 into the interior of the bag 106. As illustrated in FIG. 4 the valve 116 drops into place in the assembly housing 111. Once a bag 106 is exhausted the bag and its attached valve 116 are discarded. In this way no liquid-contacting part of the bag or valve is re-employed and no remnants of spoiling liquid can contaminate liquid being dispensed from a fresh bag. The need to carefully clean the permanent parts of the dispenser is greatly reduced.

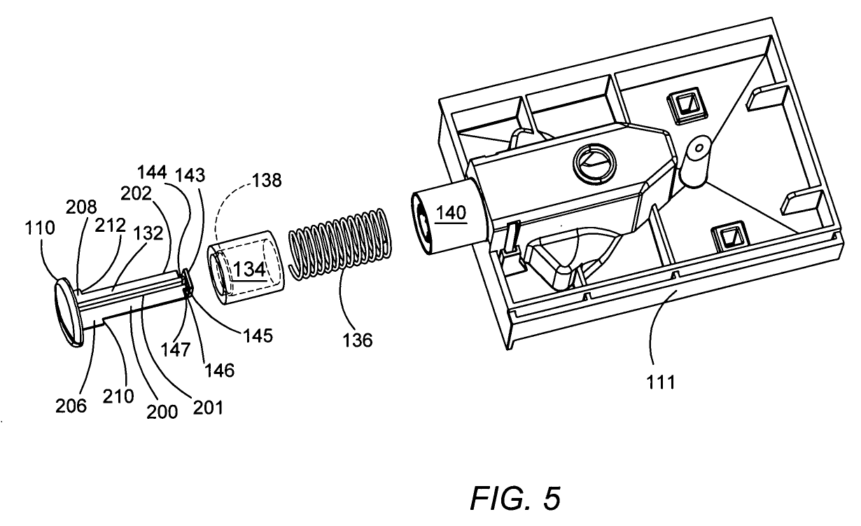

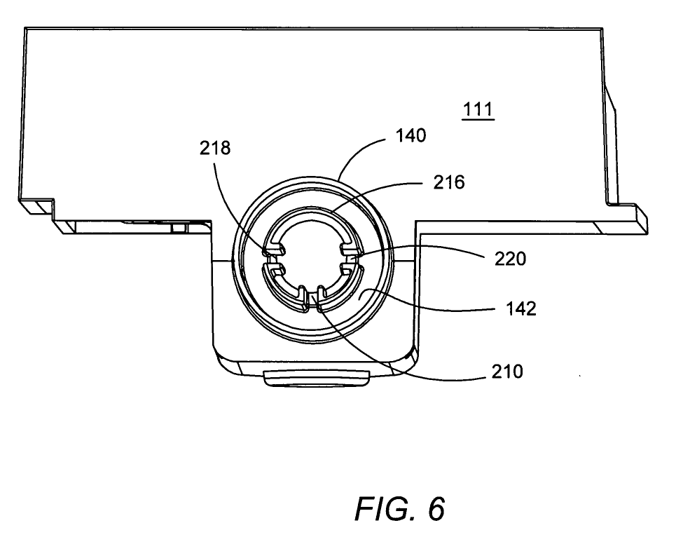

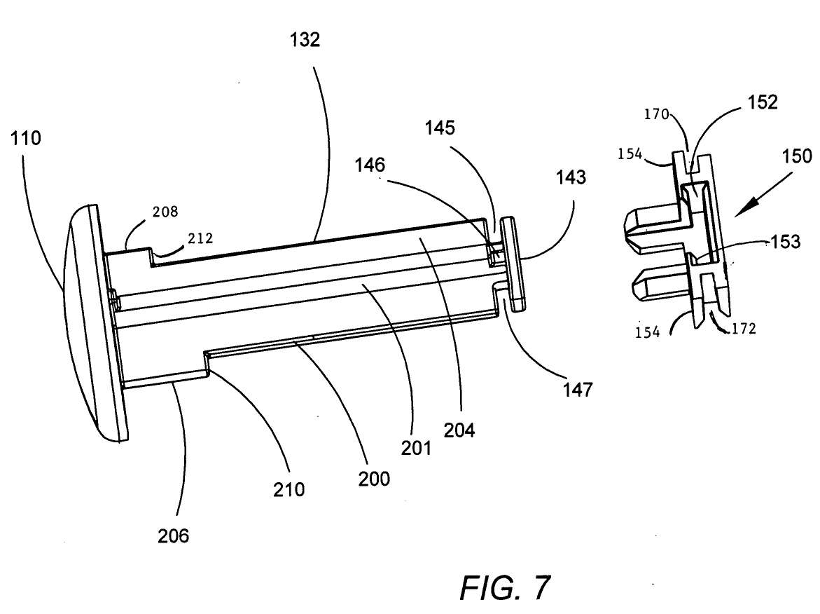

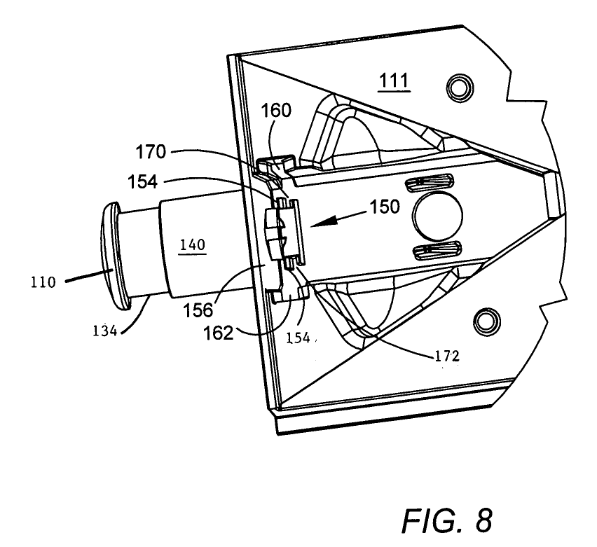

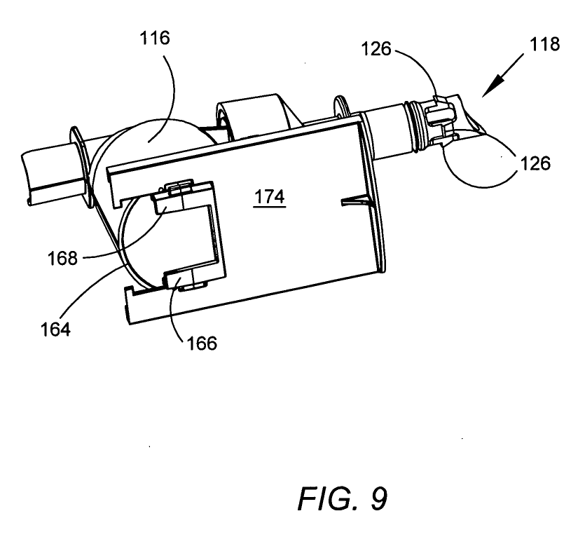

In the exploded view of FIG. 5 a plunger stem 132 can be seen affixed to the plunger head 110. The stem 132 extends into and through a cylindrical collar 134 and the end of a coil spring 136 fits into the collar 134 and engages a shoulder 138 formed in the interior at the end of the collar closest to the plunger head 110. The farther end of the spring 136 extends into a further collar 140 that also telescopically accepts the first-mentioned collar 138. Within the collar 140 the inserted spring end abuts a further circular shoulder 142 best seen in FIG. 6. As best seen in FIGS. 2 and 4, the telescoping collars 134 and 140 serve to mask the contained spring 136 and plunger stem 132. Returning to FIG. 5, it can be seen that the plunger stem 132 ends in small, square foot 143 set off by slots 144-147. A coupler 150 best illustrated in FIG. 7 has a pair of inward facing slots 152 and 153 to receive the foot 143 with the plunger stem rotationally oriented in one of four directions. The coupler 150's purpose is two fold. Installed on the foot 143 of the plunger stem 132, as seen best in FIG. 8, its flanges 154 engage the interior surface 156 of the housing 110 and prevent the plunger being forced from the housing 110 by the bias of spring 136. Also, when the valve 116 is moved into place as illustrated in FIG. 4, with the coupling 150 pushed slightly inward into alignment with a pair of housing slots 160 and 162 as illustrated in FIG. 8, the coupler 150 joins the plunger to a piston 182 in the valve 116. A valve piston's external surface 164 (FIG. 9) is formed with a pair of tabs 166 and 168. These serve to couple to the plunger foot 150. The tabs 166 and 168 of FIG. 9 slip into a pair of outward facing slots 170 and 172 on the coupler 150 as best seen in FIG. 8. To slide the valve 116 into place an upwardly extending and manually engageable slide 174 permits the valve 116 to be held and moved into and out of place as shown in FIG. 4.

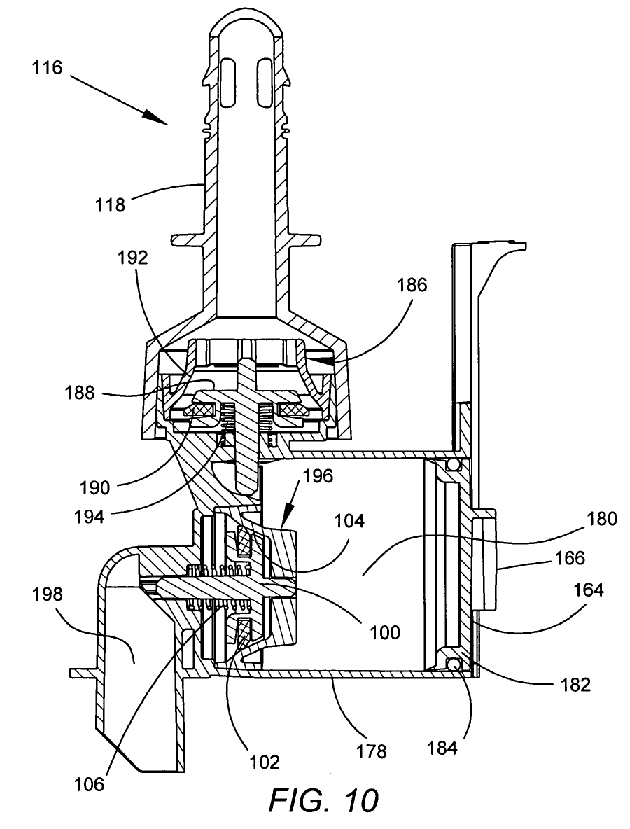

The internal workings of the valve 116 are best understood with respect to FIG. 10. A main body 178 of the valve defines a chamber 180. A piston 182 is slidable within the chamber and is sealed around its periphery by an O ring 184. It is the outer face of this piston 182 that carries the pair of tabs 166 and 168 that connect with the coupling 150. When the plunger head 110 is pushed inward, the piston 182 moves to the left in FIG. 10. With a liquid filled flexible bag 106 attached to the connector 118, when the piston 182 is retracted to its position shown in FIG. 10 by the spring 136 acting on the plunger head 110, liquid from a bag 106 is drawn into and through the connector 118 past a first poppet valve 186 and into the chamber 180. In other words, retraction of the piston 182 towards its position illustrated in FIG. 10 (the compression release position) produces a vacuum or partial vacuum (i.e. reduced pressure) within the chamber 180. The pressure differential across a poppet 188 drives that poppet and its ring seal 190 away from its seat 192 against the bias of the poppet's spring 194. Liquid, of course, flows from the bag into the connector 118 past the poppet 188 into the chamber 180. When the plunger head 110 is again pushed in to drive the piston 182 leftward in FIG. 10 to a compression position, a second poppet valve 196 opens and liquid is dispensed past that poppet valve and through an outlet channel 198 communicating with a spout 114 as shown in FIGS. 1 and 2. In other words, forcing the piston 182 to the left in FIG. 10 by depressing the plunger head 110 increases the pressure within the chamber 180. The pressure differential across the poppet 100 forces the poppet and the poppet's ring seal 102 away from a seat 104 against the bias of the spring 106, allowing liquid to be forced from the chamber 180 to a waiting cup, for example.

The amount of liquid dispensed is controlled by limiting the travel of the valve piston 182. As shown in FIGS. 5 and 7 the stem 132 of the plunger is cruciform in section. It has four elongate ribs 200-203. Two of these ribs, 200 and 202, have enlarged ends 206 and 208 that form shoulders 210 and 212, respectively, at different locations along the length of the stem 132.

Returning now to FIG. 6, it will be seen that within the collar 140 formed on the housing 111 is a cylindrical projection 216 broken by three lengthwise slots 218, 219 and 220. As seen in FIG. 6, the slots are at nine o'clock, six o'clock and three o'clock. There is no slot at twelve o'clock.

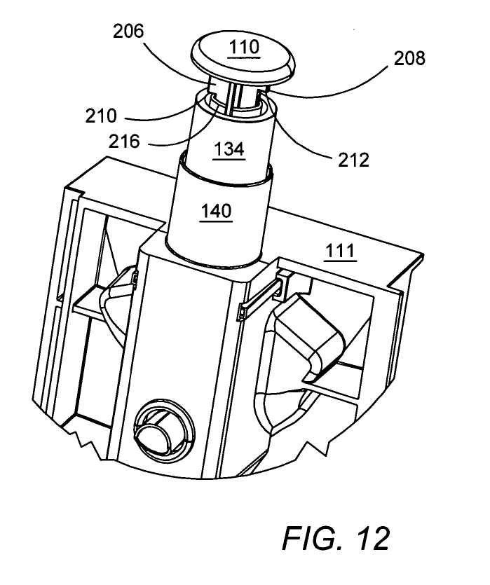

FIG. 12 shows the plunger in place in the collar 140 but with the collar 134 and spring 136 removed for clarity. It will be seen that the narrower lengths of the ribs 200 and 202 fit within the interior of the cylindrical projection 216. The enlarged rib portions 206 and 208 do not, however. The shoulder 210 of the enlarged rib portion 206 has engaged the unslotted twelve o'clock location on the cylinder 216. This limits the travel of the plunger. The travel of the internal piston 182 (FIG. 10) will likewise be limited and a volume of liquid less than the full volume of the chamber 180 will be dispensed as a result.

Similarly, the piston of FIG. 12 can be rotated 180 degrees before being coupled to the piston 182 of the internal valve 116. The shoulder 212 of the enlarged rib portion 208 will then engage the twelve o'clock location on the cylindrical projection 216. In that case the enlarged rib section 206 will simply extend into the slot at twelve o'clock in FIG. 6. and move inward until the shoulder 212 engages the edge of the cylindrical projection 216. Finally, rotated 90 degrees in either direction, the head 110 of the plunger can be fully depressed to the collar 140 representing a full throw of the valve piston 182 of FIG. 10, since both enlarged rib portions 206 and 208 and their shoulder 210 and 212 are now aligned with the slots 218 and 220 and move freely past the end of the cylindrical projection 216. Consequently three volumetric portions can be set by the positioning of the plunger in the exemplary embodiment here described.

It will be seen, then, that a disposable, variable portion dispensing valve has been provided. Relocation of the shoulders 210 and 212 along the length of the plunger stem permits other measured amounts of liquid to be dispensed as desired. Additional plunger stem shoulders and slots in the cylindrical projection can afford a greater number of portion choices. Activation of the plunger by a solenoid, not shown, will be within the skill of the ordinarily skilled artisan.

Rotation of the collar 140 and its slotted cylindrical projection may be readily accomplished as an alternative means of setting portion amount. That can also be accomplished automatically by use of known servo controls, stepper motors or the like.

While a preferred and exemplary embodiment has been described here, it will be appreciated that various modifications, alterations and the like are possible within the spirit and scope of the invention as set forth in the following claims.
We claim:

1. A dispenser assembly that dispenses controlled portions of a product comprising:
(a) a body defining an internal passageway extending between an inlet port adapted to be in fluid communication with a product container to an internal chamber and from the internal chamber to an outlet port adapted to dispense product;
(b) an inlet valve positioned in the passageway between the inlet port and the internal chamber movable between an open position, which permits fluid to flow from the inlet port into the internal chamber, and a closed position, which obstructs fluid flow between the inlet port and the internal chamber;
(c) an outlet valve positioned in the passageway between the outlet port and the internal chamber movable between an open position, which permits fluid to flow from the internal chamber to the outlet port, and a closed position, which obstructs fluid flow between the internal chamber and the outlet port;
(d) a piston positioned in the internal chamber slidable between a compression position and a compression release position, the internal chamber having a larger interior volume when the piston is in the compression release position and having a smaller interior volume when the piston is in the compression position;
(e) a plunger movable to travel in and out of the chamber having a head, a stem extending from the plunger and a plurality of stops that limit the travel of the plunger into the valve chamber;
(f) a biasing mechanism biasing the piston into the compression release position when the plunger is connected to the piston; and
(g) a coupler to interlock the plunger with the piston; wherein each stop corresponds to a predetermined amount of product to be dispensed.

2. The dispenser assembly of claim 1, wherein at least one of the plurality of stops comprises a shoulder located along the length of the stem and at least one of the plurality of stops comprises the inside wall of the plunger head.

3. The dispenser assembly of claim 1, further comprising a collar adapted to fit around the stem of the plunger and having an abutment that prevents the plunger from traveling further into the valve chamber when one of the plurality of stops engages the abutment.

4. The dispenser assembly of claim 3, wherein the collar further comprises a plurality of slots designed to permit at least some plurality of stops to slide through the collar.

5. The dispenser assembly of claim 1, wherein the plunger stem has a cruciform cross-section.

6. The dispenser assembly of claim 1, wherein the plunger comprises a plurality of elongate ribs, each rib having one of the plurality of stops, the stops being at different locations along the length of the stem.

7. The dispenser assembly of claim 1, wherein the dispenser assembly limits the volume of product dispensed from the dispenser assembly by limiting the travel of the piston.

8. The dispenser assembly of claim 1, wherein the dispenser dispenses various volumetric portions of product, each volume dependent upon the distance the plunger can travel into the internal chamber.

9. The dispenser assembly of claim 1, wherein both the outlet valve and the inlet valve are poppet valves.

10. The dispenser assembly of claim 1, further comprising an intake connector adapted to interact with a fitment on a product container.

11. The dispenser assembly of claim 10, wherein the intake connector has an intake projection that penetrates a seal of a product container.

12. The dispenser assembly of claim 11, wherein the intake connector further comprises resilient plastic barbs on the sides of the connector which are adapted to move inward when the connector is inserted in an opening of a product container fitment and then spring outward so as to lock irremovably the connector to the fitment upon insertion of the connector into an interior of a product container.

13. The dispenser assembly of claim 1, wherein the product container is a flexible bag.

14. The dispenser assembly of claim 1, wherein the piston is sealed around its periphery by an O-ring.

15. The dispenser assembly of claim 1, wherein the dispenser assembly draws product from a product container through the inlet port and the inlet valve and into the interior chamber when the piston moves from the compressed position to the uncompressed position.

16. The dispenser assembly of claim 1, wherein the dispenser assembly pushes product located in the interior chamber out of the interior chamber, through the outlet valve and out of the outlet port when the piston moves from the compression release position to the compression position.

17. The dispensing assembly of claim 1, wherein the coupler is adapted to interlock with the piston while rotationally orientated in one of a plurality of rotational positions.

18. The dispensing assembly of claim 17, wherein the number of the plurality of rotational positions is four.

19. The dispensing assembly of claim 1, wherein the coupler comprises a pair of inward facing slots that receive and interlock with the stem of the plunger.

20. The dispensing assembly of claim 1, wherein the plunger stem ends in square-shaped foot.

21. The dispensing assembly of claim 20, wherein the coupler interlocks with the foot.

22. The dispensing assembly of claim 1, wherein the coupler connects to a piston connector affixed to an outer face of the piston.

23. The dispensing assembly of claim 22, wherein the piston connector comprises a pair of tabs located on an outer surface of the piston that removably interlock with a pair of outwardly facing slots of the connector.

24. A method of operating a portion control dispensing valve comprising the steps of:
(a) selecting one of a plurality of predetermined dispensing amounts by setting a plunger in a predetermined orientation;
(b) interlocking a piston located in an interior chamber of the dispensing valve with the plunger;
(c) activating the portion control valve by:
(i) pushing the plunger into the interior chamber;
(ii) forcing the piston to move into a compression position;
(iii) opening an outflow poppet and dispensing product;
(d) engaging a stop located on the piston with an abutment of the dispensing valve, thereby limiting the travel of the plunger into the interior chamber;
(e) releasing the plunger, thereby causing a biasing spring to return the plunger to an outward position to:
(i) pull the piston into a compression release position to create a pressure reduction within a portion of the interior chamber; and
(f) opening an inflow poppet and drawing product into the interior chamber.

25. The method of claim 24, further comprising attaching an intake connector of the dispensing valve with a fitment of product container containing product to be dispensed.

26. The method of claim 24, wherein the interlocking step further comprises connecting a foot of the plunger to a coupler in one of a plurality of orientations.

27. The method of claim 24, wherein the interlocking step further comprises interlocking the coupler to a connector located on an outside wall of the piston.

28. The method of claim 24, further comprising dispensing a predetermined amount of product corresponding to the rotational orientation of the plunger.
